(19) United States
(12) Patent Application Publication
(10) Pub. No.: US 2018/0054374 A1
(43) Pub. Date: Feb. 22, 2018

(54) TRACE INFORMATION ENCODING APPARATUS, ENCODING METHOD THEREOF, AND READABLE COMPUTER MEDIUM

(71) Applicant: ANDES TECHNOLOGY CORPORATION, Hsin-Chu City (TW)

(72) Inventor: Zhong-Ho Chen, Taichung City (TW)

(73) Assignee: ANDES TECHNOLOGY CORPORATION, Hsin-Chu City (TW)

(21) Appl. No.: 15/241,083

(22) Filed: Aug. 19, 2016

(51) Int. Cl. H04L 12/26; H04L 29/06; H04L 12/805

(52) U.S. Cl. CPC H04L 43/10; H04L 47/365; H04L 43/18; H04L 69/22

(57) ABSTRACT

The trace information encoding method includes: receiving events from at least one processor; generating a stream of data packets according to the events, wherein each of the data packets is composed of N data blocks, and N is a positive integer; and, writing a boundary values to each of the N data blocks.

### BACKGROUND

### Field of the Invention

The invention relates to a trace information encoding apparatus, encoding method thereof. Particularly, the invention relates to the trace information encoding apparatus, encoding method thereof for recoding boundary information of a data packet.

### Description of Related Art

For diagnosing events of a processor, one or more trace packet(s) can be generated by a trace information encoder. In conventional art, the trace packets can be stored in a circular buffer. For reducing trace bandwidth, data width of each of the trace packets is variable. That is, if an oldest data packet is overwritten by a newest data packet, boundary information of each of the data packets in the circular buffer can't be determined.

### SUMMARY OF THE INVENTION

The invention is directed to a trace information encoding apparatus, encoding method thereof, and a readable computer medium for generating a data packet with boundary information.

The present disclosure provides the trace information encoding method, including: receiving events from at least one processor; generating a stream of data packets according to the events, wherein each of the data packets is composed of N data blocks, and N is a positive integer; and, writing a boundary value to each of the N data blocks.

The present disclosure provides the trace information encoding apparatus including an event buffer and an encoder. The event buffer is coupled to at least one processor, receives and stores events from the at least one processor. The encoder is coupled to the event buffer. The encoder is configure to: receive the events from the event buffer; generate a stream of data packet according to the events, wherein each of the data packets is composed of N data blocks, and N is a positive integer; and write a boundary value to each of the N data blocks. Wherein, the boundary value indicates whether the corresponding data block is a boundary data block.

The present disclosure provides the readable computer medium including a plurality of program code segments. The program code segments can be loaded into an electronic apparatus to execute the following steps: receiving events from at least one processor; generating a stream of data packets according to the events, wherein each of the data packets is composed of N data blocks, and N is a positive integer; and, writing a boundary value to each of the N data blocks. Wherein, the boundary value indicates whether the corresponding data block is a boundary data block.

According to the above descriptions, the present disclosure provides the trace information encoding apparatus to respectively write the boundary values to the data blocks, and the boundary value is determined according to whether corresponding data block is boundary data block or not. That is, the boundary data block of the data packet can be identified by the corresponding boundary value. Data loss of the data packet can be avoided.

In order to make the aforementioned and other features and advantages of the invention comprehensible, several exemplary embodiments accompanied with figures are described in detail below.

### BRIEF DESCRIPTION OF THE DRAWINGS

The accompanying drawings are included to provide a further understanding of the invention, and are incorporated in and constitute a part of this specification. The drawings illustrate embodiments of the invention and, together with the description, serve to explain the principles of the invention.

FIG. 1A illustrates a flow chart of a trace information encoding method according to an embodiment of present disclosure.

FIGS. 1B-1D illustrate block diagrams of systems for executing the trace information encoding method according to an embodiment of present disclosure.

FIG. 2 illustrates a schematic diagram of a data packet according to an embodiment of present disclosure.

FIG. 3 illustrates a schematic diagram of a circular buffer according to an embodiment of present disclosure.

FIG. 4 illustrates a schematic diagram of a data packet corresponding to synchronization information according to an embodiment of present disclosure.

FIG. 5 illustrate a schematic diagram of a data packet corresponding to branch instruction executing information according to an embodiment of present disclosure.

FIG. 6 illustrate a schematic diagram of a data packet corresponding to indirect branch instruction executing information according to an embodiment of present disclosure.

FIG. 7 illustrate a schematic diagram of a data block of a data packet according to another embodiment of present disclosure.

FIG. 8A and FIG. 8B illustrate schematic diagrams of a circular buffer for storing a stream of data packets according to an embodiment of present disclosure.

FIG. 9 illustrates a block diagram of a trace information encoding apparatus according to an embodiment of present disclosure.

FIG. 10 illustrates a block diagram of an encoder according to an embodiment of present disclosure.

### DETAILED DESCRIPTION OF DISCLOSED EMBODIMENTS

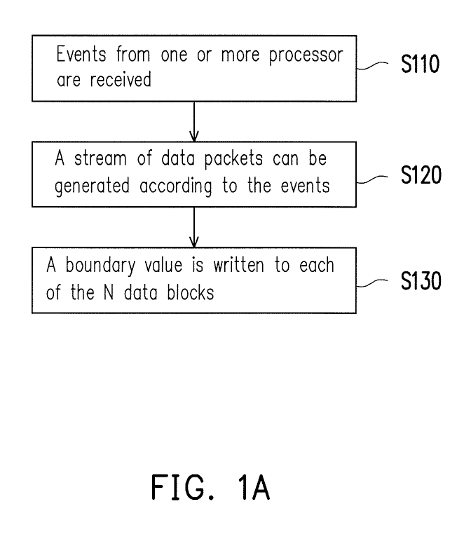

Please refer to FIG. 1A, FIG. 1A illustrates a flow chart of a trace information encoding method according to an embodiment of present disclosure. In a step S110, events from one or more processor are received. An event can be (but not limited to) current program counter, a branch instruction is executed, a load/store instruction is executed, an exception occurs, context identification is updated, a program issues a system call, trace is enabled, and timestamp. A stream of data packets can be generated according to the events in a step S120, and each of the data packets is composed of N data blocks, wherein N is a positive integer. A data block has one and only one bit for determining the first data block of a data packet and the last data block of a data packet. Moreover, in a step S130, a boundary value is written to each of the N data blocks. Wherein, the boundary value indicates the corresponding data block is a boundary data block or not, and each of the data blocks includes a boundary value. In one embodiment, a boundary data block is the last data block of a packet. In other embodiments, a boundary data block is the first data block of a packet. In detail, in the step S130, whether each of the N data blocks is the boundary data block in the data packet or not is determined. If a data block is not the boundary data block, the corresponding boundary value can be set to a first logic value, and if a data block is the boundary data block, the corresponding boundary value can be set to a second logic value. Wherein, the first logic value is inverted to the second logic value.

Please refer to FIGS. 1B-1D, FIGS. 1B-1D illustrate block diagrams of systems for executing the trace information encoding method according to an embodiment of present disclosure. In FIG. 1B, the system 100 includes a chip 110A and a diagnostic host 120A. The chip 110A includes a processor host 111A, a trace information encoding apparatus 112A, a memory device 113A, peripherals 114A and a trace buffer 115A. The processor core 111A is coupled to the memory device 113A, and the peripherals 114A through a system bus SBUS. The processor core 111A is further coupled to the trace information encoding apparatus 112A, the trace information encoding apparatus 112A is coupled to the trace buffer 115A, and the trace buffer 115A is coupled to the diagnostic host 120A.

The trace information encoding apparatus 112A is used to execute the steps in FIG. 1A, and the trace information encoding apparatus 112A stores the data packets to the trace buffer 115A, wherein the trace buffer 115A may be a circular buffer.

The diagnostic host 120A may access the data packets from the trace buffer 115A for diagnostic operation, and actions of the processor core 111A can be traced accordingly.

In FIG. 1C, the system 101 includes a chip 110B, a trace buffer 115B, and a diagnostic host 120B. The chip 110B includes a processor host 111B, a trace information encoding apparatus 112B, a memory device 113B, peripherals 114B and a trace port 116B. Different from FIG. 1B, the trace buffer 115B is not embedded in the chip 110B, and is external from the chip 110B. The trace buffer 115B is coupled to the trace information encoding apparatus 112B through the trace port 116B. The processor core 111B is coupled to the memory device 113B, and the peripherals 114B through a system bus SBUS.

In FIG. 1D, the system 102 includes a chip 110C. The chip 110C includes a processor code 111C, a memory device 113C and peripherals 114C. The processor code 111C is coupled to the memory device 113C and the peripherals 114C through a system bus SBUS. The memory device 113C stores trace buffer 1132 and an application code of a trace encoder 1131. The processor code 111C loads the trace encoder 1131 from the memory device 113C, and performs function of trace information encoding apparatus by executing the application code of a trace encoder 1131.

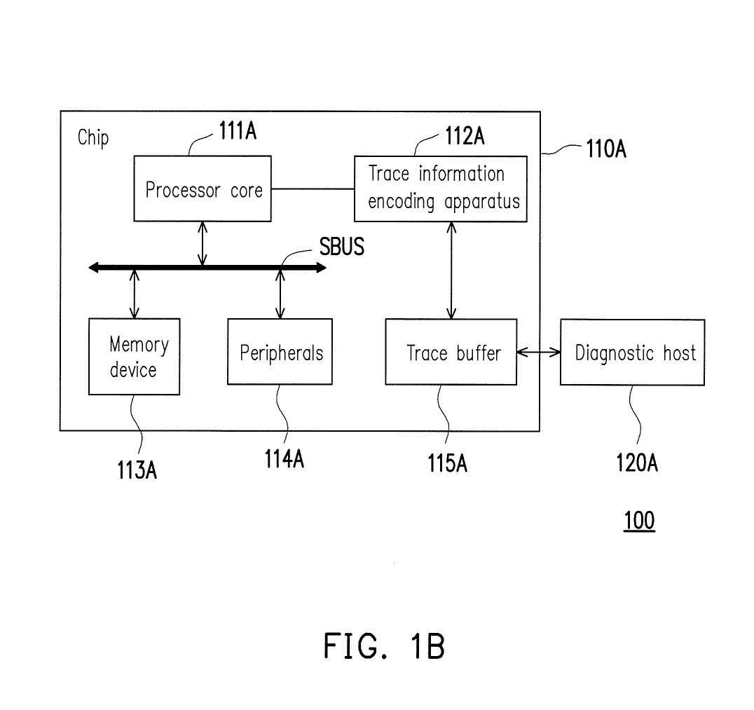

Please refer to FIG. 1A and FIG. 2 commonly, wherein FIG. 2 illustrates a schematic diagram of a data packet according to an embodiment of present disclosure. In FIG. 2, the data packet 200 is generated according to an event of a processor, and the data packet 200 has N data blocks 211-21N. The N data blocks 211-21N respectively record data A1-data AN of the event, and the N data blocks 211-21N respectively have specific bits SB1-SBN for indicating the corresponding block is the last block or record boundary values. In FIG. 2, since the data blocks 211-212 are not the last data block, the boundary values of the specific bits SB1 and SB2 of the data block 211 and 212 respectively are the first logic value (i.e. logic “1”). On the contrary, since the data block 21N is the last data block, the boundary values of the specific bit SBN of the data block 21N is the second logic value (i.e. logic “0”).

It should be noted here, a number of N is not limited to larger than 1, in some embodiment, the data packet merely include one data block. In this case, the only one data block is the first and last data block, and boundary value of this only one data block is logic “0”.

The data width of each of the N data blocks 211-21N may be one byte, and the specific bit for storing the boundary value may be the most significant bit (MSB) of each of the N data blocks 211-21N. On another embodiment, the data width of each of the N data blocks 211-21N may be one word, and the specific bit for storing the boundary value may be the least significant bit (LSB) of each of the N data blocks 211-21N.

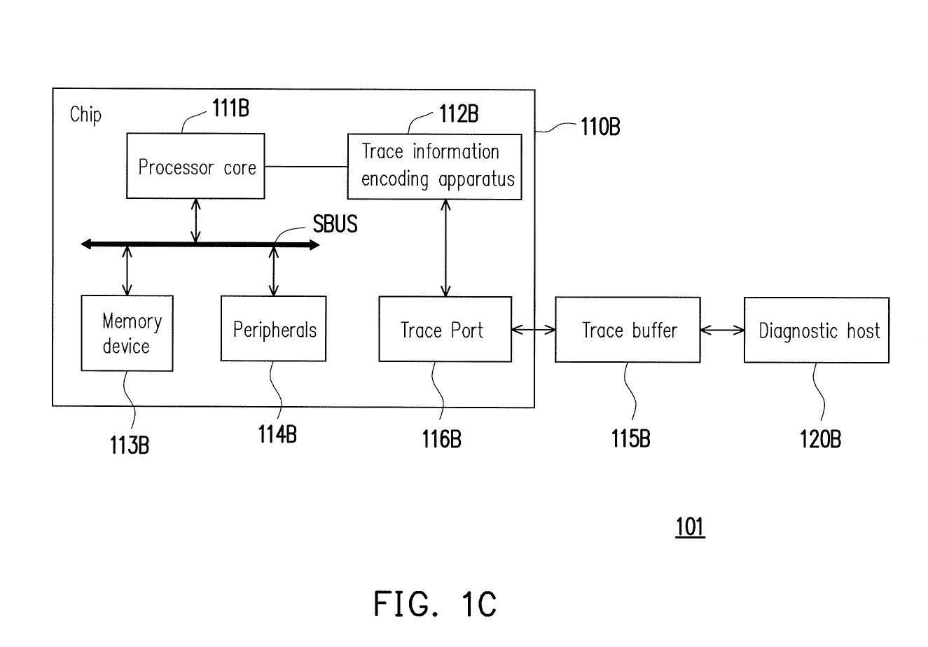

Please refer to FIG. 3, FIG. 3 illustrates a schematic diagram of a circular buffer according to an embodiment of present disclosure. The circular buffer 300 is used to store the data packets. In FIG. 3, there are data packets DP1-DP3 stored in the circular buffer 300 in sequential. The data packet DP1 includes data blocks 311-313, and data A1-data A3 are respectively stored in data blocks 311-313. Furthermore, the specific bits SB1-SB3 of the data blocks 311-313 respectively record boundary values “1”, “1”, and “0”. It can be seen, the data block 313 is the last data block of the data packet DP1, and the data block 321 next to the data block 313 is belong to the other data packet DP2.

The data packet DP2 includes only one data block 321 for storing the data B1. The data block 321 is the last block of the data packet DP2. Such as that, the boundary value of the data packet DP2 is logic “0”. Further, the data packet DP3 includes the data blocks 331 and 332. The data blocks 331 and 332 respectively store data C1 and data C2. The data blocks 331 is not the last data block of the data packet DP3, and the boundary value stored in the specific bit SB5 is logic “1”. On the contrary, the data blocks 332 is the last data block of the data packet DP3, and the boundary value stored in the specific bit SB6 is logic “0”.

By the illustration of FIG. 3, when a diagnostic operation is operated, the circular buffer 300 can be accessed by a diagnostic host. The diagnostic host can identify each boundary of each of the data packets DP1-DP3, and data in the data packets DP1-DP3 can be obtained correctly.

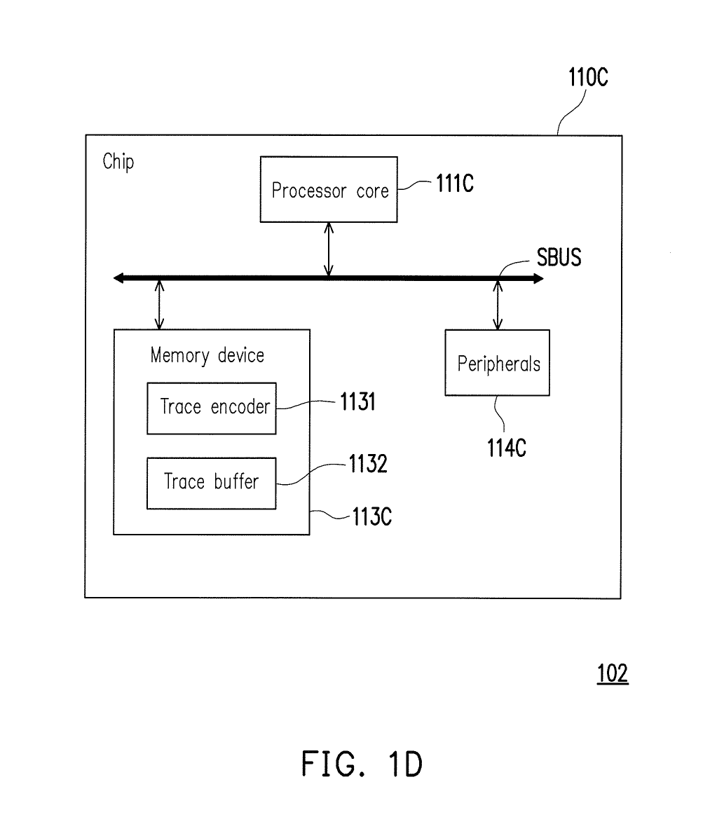

Please refer to FIG. 4, FIG. 4 illustrates a schematic diagram of a data packet corresponding to synchronization information according to an embodiment of present disclosure. The data packet 400 corresponds to synchronization information of a processor, and includes data blocks 411-416. The synchronization information includes an address of a program counter. The address of the program counter is divided to a plurality of sub-addresses ADD1-ADDS, and be stored in a plurality of fields 412a-416a, respectively. Wherein, the fields 412a-416a are respectively included in the data blocks 412-416. Furthermore, in the data packet 400, the data blocks 411-415 are not the last data block, the boundary values BV1-BVS are logic “1”, and the data block 416 is the last data block, the boundary values BV6 is logic “0”.

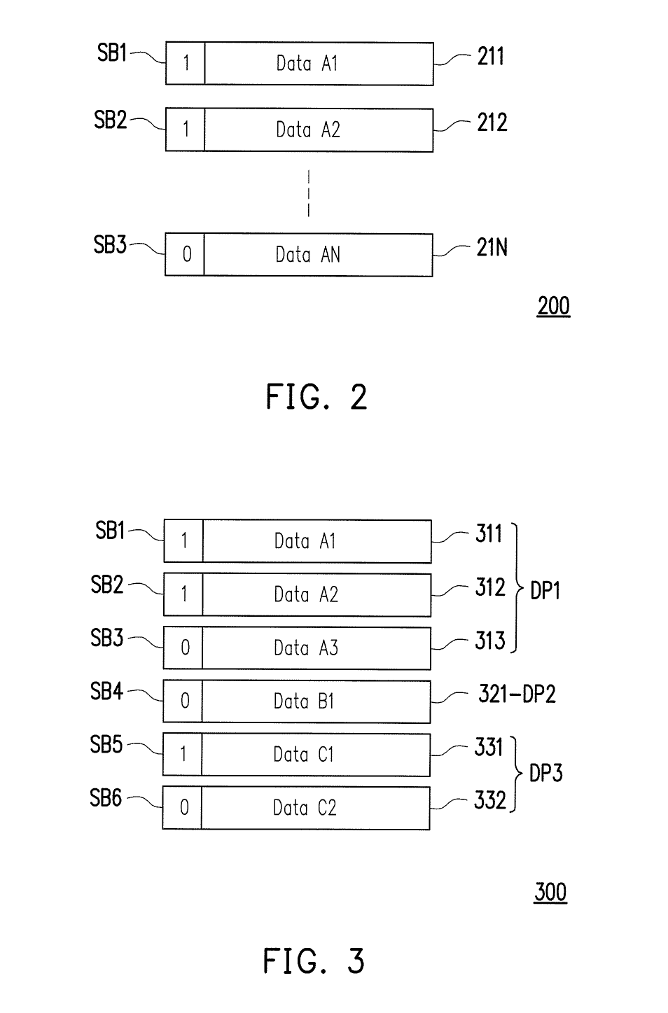

Please refer to FIG. 5, FIG. 5 illustrate a schematic diagram of a data packet corresponding to branch instruction executing information according to an embodiment of present disclosure. The data packet 500 corresponds to branch instruction executing information of a processor, and only one data block 511 (a direction data block) is set to be included in the data packet 500. A bit in the data block 511 is used to store a flag DIR for indicating direction information of the branch instruction executing information in a bit B1. For example, if the flag DIR is logic “1”, a direct branch operation is taken by the processor, and if the flag DIR is logic “0”, a direct or indirect branch operation is not taken by the processor.

Since the data block 511 is the last data block, such as that, the boundary value BV51 with logic “0” is written to the specific bit SB of the data block 511.

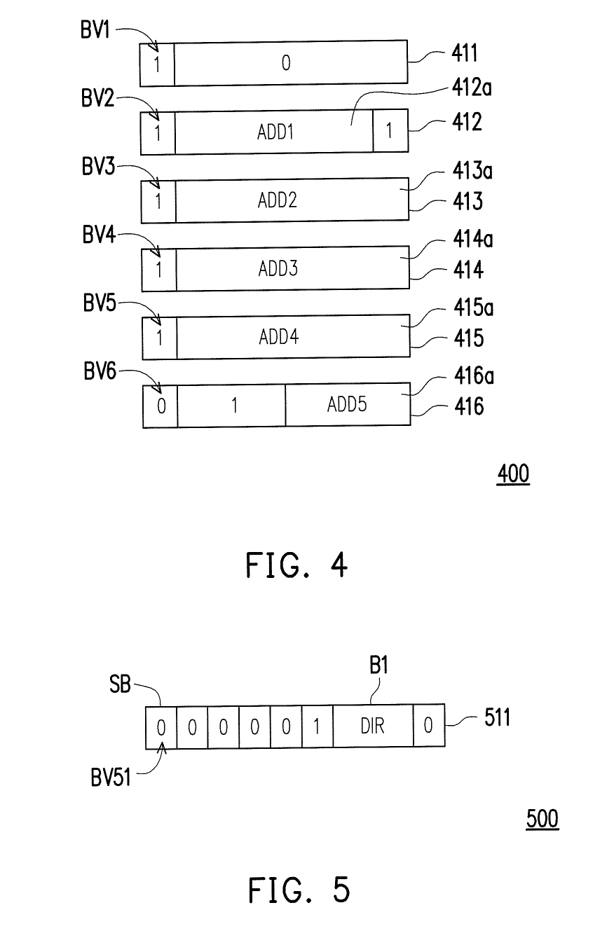

Please refer to FIG. 6, FIG. 6 illustrate a schematic diagram of a data packet corresponding to indirect branch instruction executing information according to an embodiment of present disclosure. For obtaining the data packet 600 corresponding to indirect branch instruction executing information, a branch target address of the indirect branch instruction executing information is compared by the original address, and an updated address can be obtained. The updated address is divided into a plurality of sub-addresses UADD1-UADD4, and the sub-addresses UADD1-UADD4 are respectively stored in a plurality of fields 612a-615a. The fields 612a-615a are respectively included in the data blocks 612-615.

It should be noted here, a number of the data blocks 612-615 is not fixed, and the number of the data blocks 612-615 can be determined by a comparing result of the address comparing operation for comparing the branch target address and the original address. For example, by comparing the branch target address BADD[28:1] and the original address OADD[28:1] bitwise, if a part of the branch target address BADD[10:1] is different from a part of the original address OADD[10:1], and another part of the branch target address BADD[28:11] and another part of the original address OADD[28:11] are the same, the update address can be generated by the BADD[10:1]. That is, a data width for the update address is 13 bits, if a data width for each of the data blocks 612-615 is one byte, there are two fields needed for storing the update address.

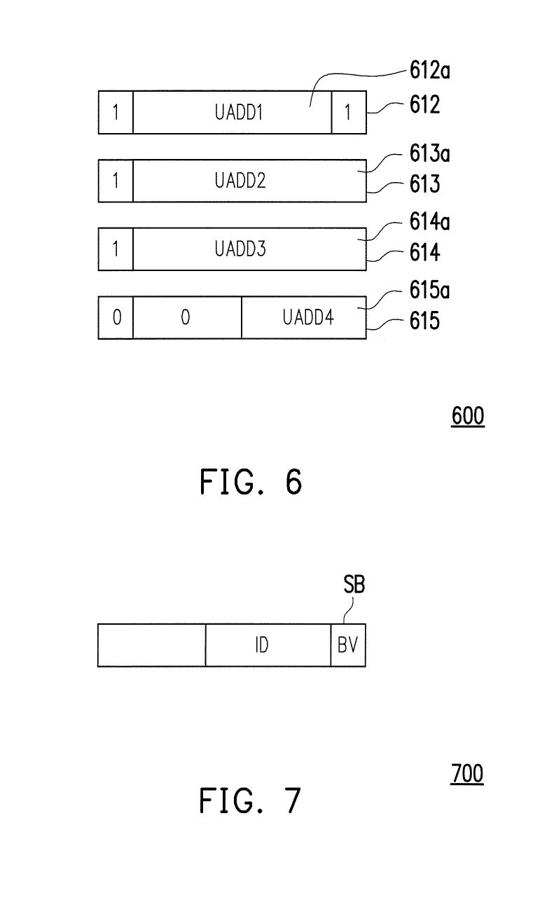

Please refer to FIG. 7, FIG. 7 illustrate a schematic diagram of a data block of a data packet according to another embodiment of present disclosure. A data width of the data block 700 is one word. The specific bit SB may be set to be a least significant bit (LSB) of the data block 700, and the boundary value BV may be stored in the LSB of the data block 700. Furthermore, identification data ID of the data packet can be written into the data block 700. The identification data ID is processor identification of event source.

In another embodiment, if a number of the data block(s) of the data packet is larger than 1, the identification data ID can be written into one of the data blocks, for example, the first data block.

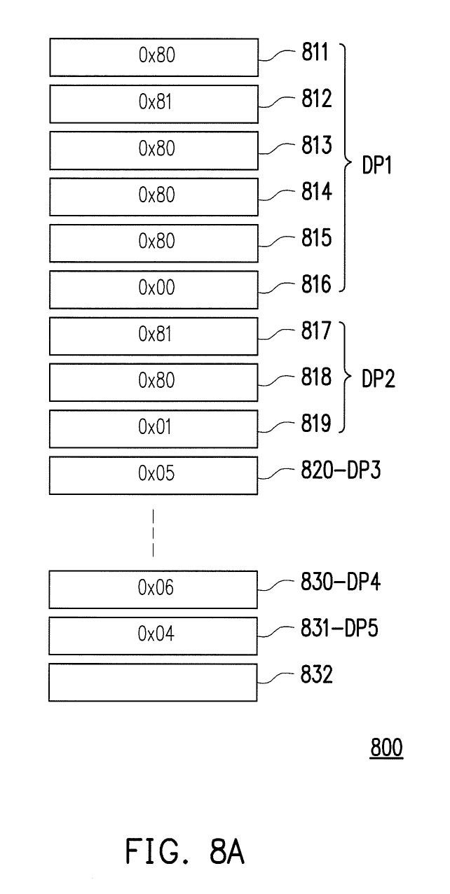

Please refer to FIG. 8A and FIG. 8B, FIG. 8A and FIG. 8B illustrate schematic diagrams of a circular buffer for storing a stream of data packets according to an embodiment of present disclosure. In FIG. 8A, a circular buffer 800 including 32 byte is provided. The circular buffer 800 stores 32 data blocks 811-832. For example, the boundary value of each of the data blocks 811-832 is stored in the MSB of each of the data blocks 811-832. By decoding the data blocks 811-832, a first data packet DP1 including the data blocks 811-816, a second data packet DP2 including the data blocks 817-819, a third to a fifth data packets DP3-DP5 respectively including the data blocks 820, 830, and 831 can be obtained. The data packet DPI corresponds to the synchronization information, and the address of the program counter is set at 0x0000. The data packet DP2 corresponds to the indirect branch instruction executing information, an indirect branch is taken, and the address of branch target is 0x4000. Moreover, the data packets DP3-DP4 indicate a plurality of branch operations are taken by the processor.

It should be noted here, in FIG. 8A, because of the data block 832 is empty, a write point of the circular buffer 800 is set to the data block 832, and a wrap flag is not enabled (be set to logic “0”).

In FIG. 8B, new event is generated, and a new indirect branch operation is taken, data 0x85 is write into the data packet 832 and data 0x40 is write into the data packet 811 to overwrite the original data. Such as that, the wrap flag is set to logic “1” (to be enabled), and the write point of the circular buffer 800 is set to the data block 811.

It should be noted here, although data of the data packet DP1 is corrupted, by identifying the boundary value in the data block 816, the boundary of the corrupted data packet DP1 can be determined. That is, data in the data packets DP2-DP5 can be obtained correctly.

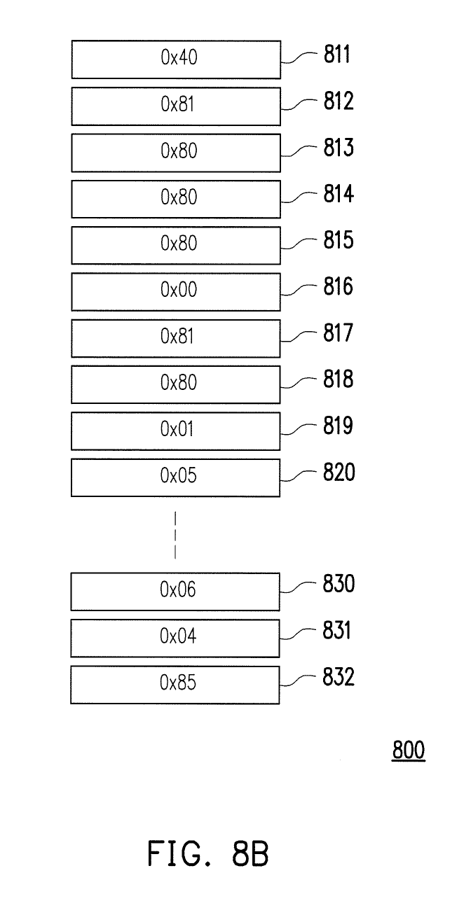

Please refer to FIG. 9, FIG. 9 illustrates a block diagram of a trace information encoding apparatus according to an embodiment of present disclosure. The trace information encoding apparatus 900 includes an event buffer 910, an encoder 920 and a packet buffer 930. The event buffer 910 is coupled to one processor CP1 or more processors CP1 and CP2. The event buffer 910 receives and stores events from the processor CP1 and/or CP2. Besides, the event buffer 910 is also coupled to the encoder 920. The encoder 920 is configure to: receive the events from the event buffer 910; generate a stream of data packets according to the events, wherein each of the data packets includes N data blocks, and N is a positive integer; and, write a boundary value to each of the N data blocks to generate one or more data packet(s) corresponding to the event in the event buffer 910, wherein, each of the boundary values indicates the corresponding data block being a boundary data block or not.

The packet buffer 910 may be a circular buffer, and is coupled to the encoder 920 for receiving and storing the data packets generated by the encoder 920.

In this embodiment, the event buffer 910, the encoder 920, and the packet buffer 930 may be implemented by hardware circuit, and he event buffer 910, the encoder 920, and the packet buffer 930 may be implemented in a same chip. In another embodiment, the packet buffer 930 may be external from the chip which includes the event buffer 910 and the encoder 920.

In this embodiment, the encoder 920 can be a logic circuit, and can be designed by hardware description language or any other digital circuit design scheme. Detail operations of the encoder 920 is shown in above embodiments, there is no repeated description here.

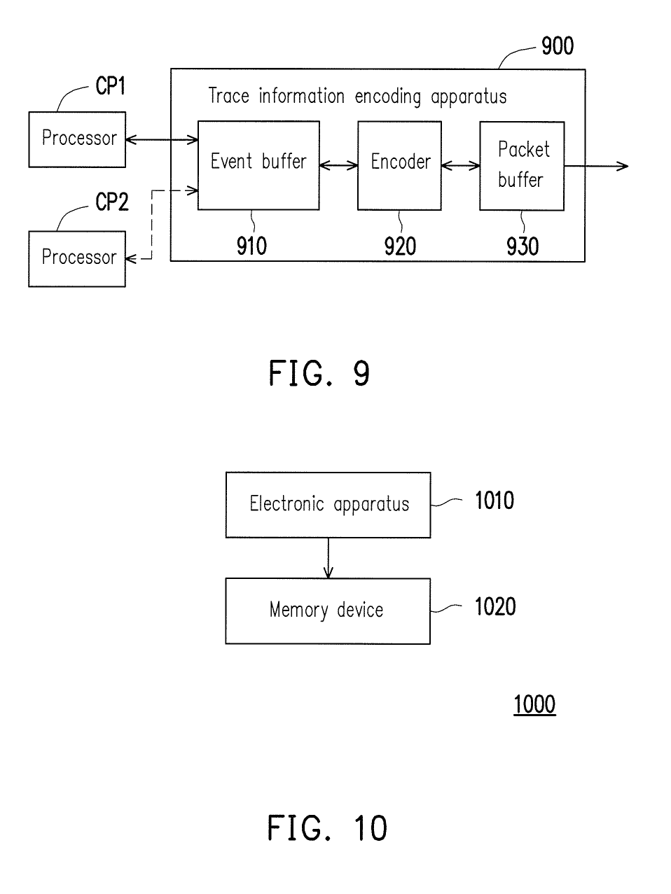

Please refer to FIG. 10, FIG. 10 illustrates a block diagram of an encoder according to an embodiment of present disclosure. In FIG. 10, the encoder 1000 for encoding trace information can be implemented by an electronic apparatus 1010. The electronic apparatus 1010 is coupled to a memory device 1020, and a readable computer medium is stored in the memory device 1020. The electronic apparatus 1010 includes a processor which can executing the readable computer medium in the memory device 1020. When the electronic apparatus 1010 is configured to be the encoder 1000, the electronic apparatus 1010 accesses the readable computer medium from the memory device 1020 for executing, and function of the encoder 1000 can be performed by the electronic apparatus 1010. Wherein, the function of the encoder 1000 is same to the encoder 920 mentioned above.

In this embodiment, the memory device 1020 may be any hardware device which can store data, and is known by person skilled in the art.

In summary, present disclosure provides to write boundary values into the data blocks of the data packet. That is, boundary information of each of the data packets in the circular buffer can be identified, and even when the data packet is corrupted, the boundary of the corrupted data packet can be determined. Data of the un-corrupted data packets can be obtained accuracy.

It will be apparent to those skilled in the art that various modifications and variations can be made to the structure of the invention without departing from the scope or spirit of the invention. In view of the foregoing, it is intended that the invention cover modifications and variations of this invention provided they fall within the scope of the following claims and their equivalents.

What is claimed is:

1. A trace information encoding method, comprising:
receiving events from at least one processor;
generating a stream of data packets according to the events, wherein, each of the data packets is composed of N data blocks, and N is a positive integer; and
writing a boundary value to each of the N data blocks.

2. The trace information encoding method as claimed in claim 1, wherein the step of writing the boundary value to each of the N data blocks comprises:
writing a logic value to boundary data blocks
writing an inverted logic value to the other data blocks

3. The trace information encoding method as claimed in claim 2, wherein the step of writing the logic value to the boundary data blocks comprises:
writing the logic value to a last data block of a data packet.

4. The trace information encoding method as claimed in claim 2, wherein the step of writing the logic value to the boundary data blocks comprises:
writing the logic value to a first data block of a data packet.

5. The trace information encoding method as claimed in claim 1, wherein if each of the events corresponding to synchronization information, the step of generating the stream of data packets according to the events comprises:
dividing a first address of a program counter of the synchronization information into N−1 first fields, and setting the second data block to the Nth data block respectively according to the N−1 first fields.

6. The trace information encoding method as claimed in claim 5, wherein if each of the events corresponding to indirect branch instruction executing information, the step of generating the stream of data packets according to the events comprises:
comparing the first address with a second address of a branch target of the indirect branch instruction executing information to obtain an updated address; and
dividing the updated address into M second fields, and setting the second data block to the Nth data block respectively according to the M second fields.

7. The trace information encoding method as claimed in claim 1, wherein if each of the events corresponding to branch instruction executing information, the step of generating the stream of data packets according to the events comprises:
setting the data packet merely having one direction data block, and writing a flag into the direction data block,
wherein, the flag is used to indicate whether a branch operation is taken or not.

8. The trace information encoding method as claimed in claim 1, wherein a data width of each of the N data blocks is one byte or one word.

9. The trace information encoding method as claimed in claim 8, further comprising:
if the data width of each of the N data blocks is one word, writing identification data of the data packet into one of the N data blocks.

10. A trace information encoding apparatus, comprising:
an event buffer, coupled to at least one processor, receiving and storing events from the at least one processor;
an encoder, coupled to the event buffer; the encoder is configure to:
receive the events from the event buffer;
generate a stream of data packets according to the events, wherein each of the data packets is composed of N data blocks, and N is a positive integer; and
write a boundary value to each of the N data blocks,
wherein, each of the boundary values indicates the corresponding data block is a last data block or not.

11. The trace information encoding apparatus as claimed in claim 10, further comprising:
a packet buffer, coupled to the encoder, storing the data packet generated by the encoder.

12. The trace information encoding apparatus as claimed in claim 10, wherein if each of the data blocks is not the last data block, the encoder sets the corresponding boundary value to a first logic value, and if each of the data blocks is not the last data block, the encoder sets the corresponding boundary value to a second logic value,
wherein, the first logic value is inverted to the second logic value.

13. The trace information encoding apparatus as claimed in claim 10, wherein the encoder writes each of the N boundary values to a specific bit of the corresponding data block.

14. The trace information encoding apparatus as claimed in claim 13, wherein the specific bit of each of the N data blocks is a most significant bit (MSB) or a least significant bit (LSB) of each of the N data blocks.

15. The trace information encoding apparatus as claimed in claim 10, wherein if each of the events corresponding to synchronization information, the encoder divides a first address of a program counter of the synchronization information into N−1 first fields, and sets the second data block to the Nth data block respectively according to the N−1 first fields.

16. The trace information encoding apparatus as claimed in claim 15, wherein if each of the events corresponding to indirect branch instruction executing information, the encoder compares the first address with a second address of a branch target of the indirect branch instruction executing information to obtain an updated address; and divides the updated address into M second fields, and setting the second data block to the Nth data block respectively according to the M second fields.

17. The trace information encoding apparatus as claimed in claim 10, wherein if each of the events corresponding to branch instruction executing information, the encoder sets the data packet merely having one direction data block, and writes a flag into the direction data block,
wherein, the flag is used to indicate whether a branch operation is taken or not.

18. The trace information encoding apparatus as claimed in claim 10, wherein a data width of each of the N data blocks is one byte or one word.

19. The trace information encoding apparatus as claimed in claim 18, wherein if the data width of each of the N data blocks is one word, the encoder writes identification data of the data packet into one of the N data blocks.

20. A readable computer medium, comprising a plurality of program code segments loaded into an electronic apparatus to execute the following steps:
receiving events from at least one processor;
generating a stream of data packets according to the events, wherein, each of the data packets is composed of N data blocks, and N is a positive integer; and
writing a boundary values to each of the N data blocks,
wherein, each of the boundary values indicates the corresponding data block is a last data block or not.
